(19) United States
(12) Patent Application Publication
(10) Pub. No.: US 2015/0097041 A1
(43) Pub. Date: Apr. 9, 2015

(54) VEHICLE COMPRISING AIR CONDITIONING APPARATUS

(71) Applicant: Toyota Jidosha Kabushiki Kaisha, Toyota-shi Aichi-ken (JP)

(72) Inventors: Hidekazu Hirabayashi, Chiryu-shi Aichi-ken (JP); Kunihiko Jinno, Toyota-shi Aichi-ken (JP); Hiroaki Matsumoto, Nagoya-shi Aichi-ken (JP)

(21) Appl. No.: 14/493,891

(22) Filed: Sep. 23, 2014

(30) Foreign Application Priority Data
Oct. 4, 2013 (JP) 2013-209403

(51) Int. Cl. B60H 1/00

(52) U.S. Cl. CPC B60H 1/00742
USPC 237/28

(57) ABSTRACT

A vehicle includes an air conditioning apparatus for heating inside of a passenger compartment using electric power of an external power supply or of the vehicle, the apparatus being configured to be capable of executing a foot mode to blow air toward feet and a moisture prevention mode to blow air also through a defroster unit while the foot mode is selected, and a control unit that causes the air conditioning apparatus to execute remote air conditioning in which air conditioning is performed while a user is not in the vehicle, and operated air conditioning in which air conditioning is performed by the user's operation while the user is in the vehicle. The control unit limits the execution of the moisture prevention mode in the remote air conditioning more than the execution of the moisture prevention mode in the operated air conditioning.

This nonprovisional application is based on Japanese Patent Application No. 2013-209403 filed on Oct. 4, 2013 with the Japan Patent Office, the entire contents of which are hereby incorporated by reference.

### BACKGROUND OF THE INVENTION

1. Field of the Invention

The present invention relates to vehicles, and more particularly to air conditioning of vehicles.

2. Description of the Background Art

Conventionally, heating of a passenger compartment may be started in a foot mode to supply (deliver) warm air to an occupant's feet. In the foot mode, some of the warm air may be delivered through a defroster air outlet (defroster unit) in order to suppress fogging of window glass (see Japanese Patent Laying-Open No. 2002-370521, for example).

The main reason for fogging of window glass is increase in humidity in the passenger compartment. Air (warm air) supplied through the defroster air outlet is transferred to the window glass as thermal energy, and suppresses fogging of the window glass. This thermal energy is used to prevent moisture from forming on the window glass, and does not contribute much to heating of the passenger compartment. That is, some of the thermal energy that should be used for heating of the passenger compartment is absorbed by the window glass as energy for moisture prevention. The thermal energy absorbed by the glass window can be considered as loss of heating energy. If loss of heating energy occurs, it takes time to heat the passenger compartment.

Heating of a passenger compartment can be performed before a user rides in a vehicle (so-called “pre-air conditioning”). In an electric vehicle or a hybrid vehicle that uses electric power of a battery as a running source, electric power consumed by an air conditioning apparatus used for the pre-air conditioning is supplied from, for example, the battery and a power supply outside the vehicle (external power supply) connected to the vehicle to charge the battery (see Japanese Patent Laying-Open No. 2012-076517, for example). Pre-air conditioning may be performed by setting a timer or by remote operation (remote air conditioning). If loss of heating energy occurs during heating of a passenger compartment by the pre-air conditioning, it again takes time to heat the passenger compartment.

Pre-air conditioning and remote air conditioning may be performed during charging of the battery. In that case, electric power from the external power supply is used for both charging of the battery and, for example, the remote air conditioning. Consequently, electric power for charging the battery decreases by the amount of power consumption by the remote air conditioning, and thus, it takes time to charge the battery.

### SUMMARY OF THE INVENTION

An object of the present invention is to provide a vehicle capable of reducing loss of heating energy and increase in battery charging time in the remote air conditioning and the pre-air conditioning.

In one aspect, the present invention provides a vehicle. The vehicle includes an air conditioning apparatus for heating inside of a passenger compartment using electric power of an external power supply or of the vehicle, the apparatus being configured to be capable of executing a foot mode to blow air toward feet and a moisture prevention mode to blow air also through a defroster unit while the foot mode is selected, and a control unit that causes the air conditioning apparatus to execute remote air conditioning in which air conditioning is performed while a user is not in the vehicle, and operated air conditioning in which air conditioning is performed by the user's operation while the user is in the vehicle. The control unit limits the execution of the moisture prevention mode in the remote air conditioning more than the execution of the moisture prevention mode in the operated air conditioning.

The main reason for increase in humidity in the passenger compartment is an occupant's breathing. Thus, in the operated air conditioning while the user is in the vehicle (with an occupant), air blowing through the defroster unit is necessary for moisture prevention. On the other hand, in the remote air conditioning while the user is not in the vehicle (without an occupant), there is not a great need for moisture prevention. In the vehicle having the structure described above, the execution of the foot mode (moisture prevention mode) in which air is blown also through the defroster unit is more limited in the remote air conditioning than in the operated air conditioning. That is, the frequency of air blowing through the defroster unit in the remote air conditioning is reduced as compared to the frequency in the operated air conditioning. Consequently, energy loss caused by the air blowing through the defroster is reduced.

Preferably, the control unit controls the air conditioning apparatus such that in the remote air conditioning, the moisture prevention mode is executed where an air temperature outside the vehicle (outside air temperature) is lower than a prescribed temperature.

When the air temperature outside the vehicle is low, frost may form (frosting may occur) on window glass due to radiation cooling. According to this structure, the moisture prevention mode can be executed at an outside air temperature at which frost may form, by setting the prescribed temperature appropriately. By executing the moisture prevention mode, the formation of frost on the window glass is prevented.

Preferably, the control unit controls the air conditioning apparatus such that in the remote air conditioning, the foot mode is executed where weather is prescribed weather, and the moisture prevention mode is executed where weather is not the prescribed weather.

Even where frost forms on the window glass, the frost may melt by solar heat and the like depending on the weather. In that case, the moisture prevention mode does not need to be executed. According to this structure, the execution of the moisture prevention mode can be prevented in weather in which the frost will not melt (weather which is not the prescribed weather), by setting the prescribed weather appropriately. Consequently, energy loss caused by the execution of the moisture prevention mode can be avoided.

Preferably, the control unit controls the air conditioning apparatus such that air is blown only toward a front seat of the vehicle where a seat used by the user is concentrated on the front seat.

According to this structure, where the user is seated only on the front seat of the vehicle, electric power consumed to heat the other seats can be saved.

Preferably, the control unit controls the air conditioning apparatus such that air is blown only toward a driver's seat of the vehicle where a seat used by the user is concentrated on the driver's seat.

According to this structure, where the user is seated only on the driver's seat of the vehicle, electric power consumed to heat the other seats can be saved.

Furthermore, in another aspect of the present invention, a vehicle includes an air conditioning apparatus for heating inside of a passenger compartment using electric power of an external power supply or of the vehicle, the apparatus being configured to be capable of executing a foot mode to blow air toward feet and a moisture prevention mode to blow air also through a defroster unit while the foot mode is selected, and a control unit that causes the air conditioning apparatus to execute remote air conditioning in which air conditioning is performed by operation of a remote controller, and operated air conditioning in which air conditioning is performed by operation of an operating panel in the passenger compartment. The control unit limits the execution of the moisture prevention mode in the remote air conditioning more than the execution of the moisture prevention mode in the operated air conditioning.

In the vehicle having this structure, the user can specify the remote air conditioning or the operated air conditioning; by using the operation of the remote controller or the operation of the operating panel depending on the case.

According to the present invention, loss of heating energy and increase in battery charging time can be reduced in the remote air conditioning and the pre-air conditioning.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a first diagram for illustrating a pre-air conditioning (pre-ride air conditioning drive) system.

FIG. 2 is a second diagram for illustrating a pre-air conditioning (pre-ride air conditioning drive) system.

FIG. 3 is a diagram for illustrating one example of a schematic structure of a vehicle according to an embodiment.

FIG. 4 is a first diagram for illustrating a cause of occurrence of fogging of window glass.

FIG. 5 is a second diagram for illustrating a cause of occurrence of fogging of window glass.

FIG. 6 is a diagram for illustrating air blowing through units of an air outlet provided on a front side in a passenger compartment.

FIG. 7 is a diagram for illustrating a more detailed structure of the air outlet.

FIG. 8 is a diagram for illustrating various modes.

FIG. 9 is a flow chart for illustrating processing executed in air conditioning.

FIG. 10 is a flow chart for illustrating processing executed in air conditioning in consideration of an outside air temperature.

FIG. 11 is a flow chart for illustrating processing executed in air conditioning in consideration of the weather.

FIG. 12 is a flow chart for illustrating processing executed in air conditioning in consideration of whether a user uses only a front seat or not.

FIG. 13 is a flow chart for illustrating processing executed in air conditioning in consideration of whether a user uses only a driver's seat or not.

FIG. 14 is a diagram for illustrating air blowing through units of an air outlet provided on a front side in a passenger compartment.

### DESCRIPTION OF THE PREFERRED EMBODIMENTS

Embodiments of the present invention will be hereinafter described in detail with reference to the drawings, in which the same or corresponding parts are designated by the same numerals and description thereof will not be repeated.

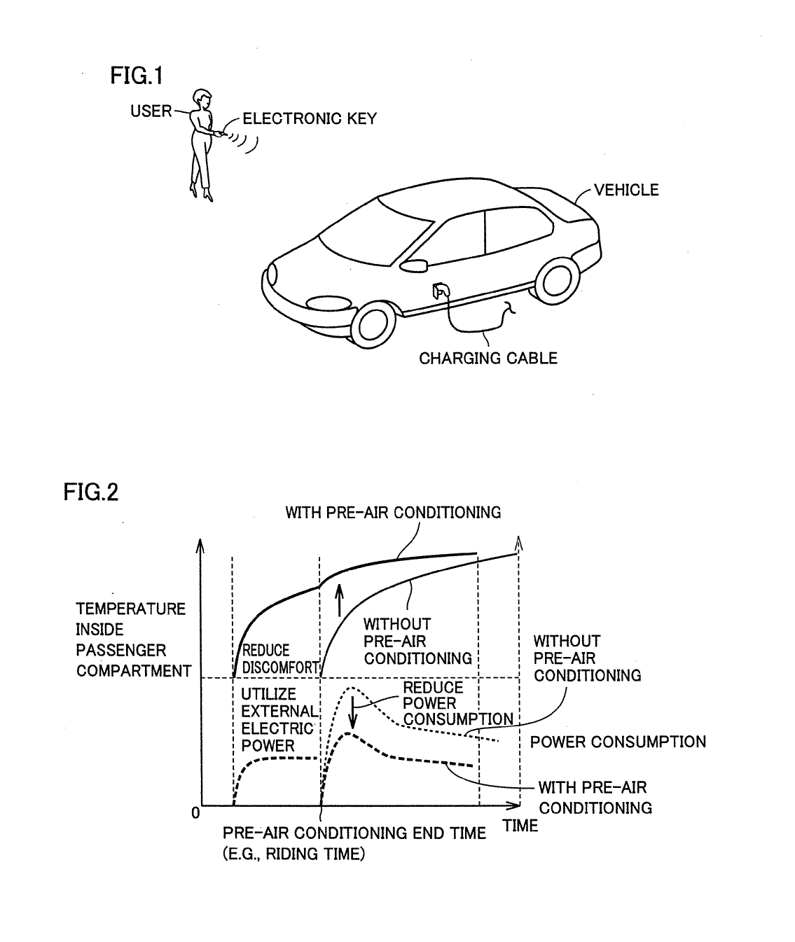

FIGS. 1 and 2 are diagrams for illustrating a pre-air conditioning (pre-ride air conditioning drive) system. FIG. 1 is a diagram for illustrating a user's operation, and FIG. 2 is a graph comparing temperatures in a passenger compartment and power consumption with and without the pre-air conditioning.

As shown in FIG. 1, the user can control the vehicle by operating an electronic key even where the vehicle is in a state in which it cannot run, for example, where the user is not in the vehicle. Instead of the electronic key, a portable communication terminal such as a smartphone may be used. The electronic key is configured to be capable of communicating with the vehicle wirelessly or the like. Operation of the electronic key includes air conditioning operation of the vehicle (remote air conditioning). The operation of the electronic key may include user verification, lock control of a vehicle door, and the like.

The vehicle is a hybrid vehicle or an electric vehicle that uses electric power of a power storage device (battery) as a running source. The battery can be charged with electric power from a power supply outside the vehicle (external power supply) through a charging cable. Such a hybrid vehicle may also be referred to as a plug-in hybrid vehicle.

The vehicle is air-conditioned by an air conditioning apparatus mounted on the vehicle. The air conditioning apparatus basically operates on electric power from the battery. Before riding in the vehicle, the user can perform air conditioning of the vehicle by operating the electronic key (pre-air conditioning). Furthermore, where the vehicle is in a state in which it can run, for example, where the user is in the vehicle, the user can perform air conditioning by operating an operating panel in the passenger compartment (operated air conditioning). When the pre-air conditioning is performed during charging of the battery, electric power from the external power supply can also be used for the pre-air conditioning.

In FIG. 2, the upper part of the graph represents temperatures in the passenger compartment. Initially, the temperature in the passenger compartment is relatively low. A low temperature in the passenger compartment gives the user a cold discomfort. Where the pre-air conditioning is not performed (“WITHOUT PRE-AIR CONDITIONING” in the graph), the temperature in the passenger compartment at a riding time is the same as that before riding. The user who has ridden in the vehicle thus feels uncomfortable. Thereafter, air conditioning is started by the user operating the operating panel, for example, and the temperature in the passenger compartment increases. On the other hand, where the pre-air conditioning is performed (“WITH PRE-AIR CONDITIONING” in the graph), air conditioning is performed prior to the riding time. The temperature in the passenger compartment is thus relatively high at the riding time. Consequently, the user who has ridden in the vehicle feels comfortable. That is, the pre-air conditioning reduces the cold discomfort felt by the user.

In FIG. 2, the lower part of the graph represents power consumption for air conditioning. Where the pre-air conditioning is not performed (“WITHOUT PRE-AIR CONDITIONING” in the graph), power consumption by air conditioning occurs after the riding time. This power consumption corresponds to power consumption of the battery. On the other hand, where the pre-air conditioning is performed (“WITH PRE-AIR CONDITIONING” in the graph), electric power from the external power supply (external electric power) is utilized prior to the riding time. Consequently, where the pre-air conditioning is performed, the power consumption by air conditioning after the riding time, that is, the power consumption of the battery, is reduced as compared to the case where the pre-air conditioning is not performed.

The air conditioning apparatus is capable of executing heating operation to supply warm air into the passenger compartment or cooling operation to supply cool air into the passenger compartment. The air conditioning apparatus is also capable of executing ventilation operation to supply outside air into the passenger compartment.

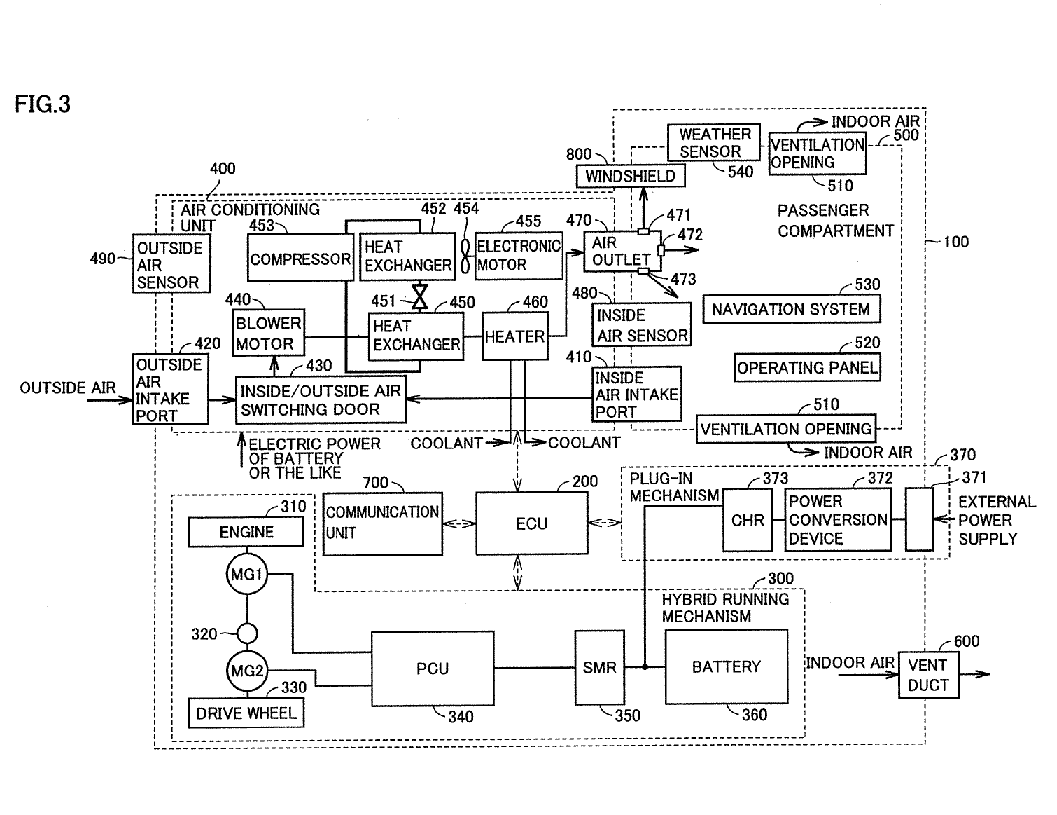

FIG. 3 is a diagram for illustrating one example of a schematic structure of a vehicle according to an embodiment. Vehicle 100 includes an ECU (Electric Control Unit) 200, which is a control unit that controls components included in vehicle 100. Vehicle 100 is a so-called plug-in hybrid vehicle. Vehicle 100 therefore includes a hybrid running mechanism 300 and a plug-in mechanism 370. Vehicle 100 also includes an air conditioning apparatus (air conditioning unit) 400 for air-conditioning the inside of passenger compartment 500. Vehicle 100 further includes a vent duct 600, a communication unit 700, and a window glass (windshield) 800.

Hybrid running mechanism 300 can drive motor generators MG1, MG2 with an internal combustion engine (engine) 310. Output torque of motor generators MG1, MG2 is transmitted to a drive wheel 330 via a power transmission gear. Electric power stored in a power storage device (battery) 360 is converted into electric power for driving motor generators MG1, MG2 by a PCU (Power Control Unit) 340. Electric power generated at motor generators MG1, MG2 may also be converted into electric power for charging battery 360 by PCU 340. A system main relay SMR switches between a connected state and a non-connected state of battery 360 and PCU 340. Electric power of battery 360 is also utilized for air conditioning unit 400.

Plug-in mechanism 370 is configured to be supplied with electric power from a power supply outside vehicle 100 through an inlet 371. Electric power supplied to inlet 371 is converted by a power conversion device 372. The converted electric power is supplied to battery 360 as charging electric power via a charging relay (CHR) 373.

Air conditioning unit 400 includes an inside air intake port 410, an outside air intake port 420, an inside/outside air switching door 430, a blower motor 440, heat exchangers 450, 452, a regulation valve 451, a compression machine (compressor) 453, an electric fan 454, an electric motor 455, a heater 460, an air outlet 470, an inside air sensor 480, and an outside air sensor 490.

Air conditioning unit 400 can execute the heating operation to supply warm air into passenger compartment 500. In the heating operation, air in passenger compartment 500 (inside air) is drawn through inside air intake port 410, or air outside vehicle 100 (outside air) is drawn in through outside air intake port 420. The drawn air passes through inside/outside air switching door 430, is blown toward heat exchanger 450 by blower motor 440, and passes through heater 460. Heater 460 may be bypassed so as to avoid heating by heater 460. Heat exchanger 450 carries out the heating function by heat pump operation utilizing regulation valve 451, heat exchanger 452, compressor 453 and the like. Heater 460 carries out the heating function by utilizing heat of a coolant of engine 310. Air that has passed through heat exchanger 450 and/or heater 460 is changed to air having a high temperature, and is supplied to air outlet 470. It is noted that the temperature of the air delivered through air outlet 470 in the heating operation (target blow temperature TAO (° C.)) is determined in consideration of various factors such as a set temperature of air conditioning unit 400, the environment (for example, solar radiation) in which vehicle 100 is placed, and the like.

It is noted that air conditioning unit 400 can execute the cooling operation and the ventilation operation in addition to the heating operation. In the cooling operation, air that has been changed to air having a low temperature by the cooling function of heat exchanger 450 is delivered into passenger compartment 500 through air outlet 470. In the ventilation operation, air (outside air) drawn in through outside air intake port 420 is delivered into passenger compartment 500 through air outlet 470 without substantially changing the temperature. Heater 460 is bypassed in the cooling operation and the ventilation operation.

Switching between the heating function and the cooling function of heat exchanger 450 is done by switching of an output direction of compressor 453. This switching is implemented by, for example, providing compressor 453 with a not-shown four-way valve. Where heat exchanger 450 carries out the heating function, the output direction of compressor 453 is switched to a direction toward heat exchanger 450. On the other hand, where heat exchanger 450 carries out the cooling function, the output direction of compressor 453 is switched to a direction toward heat exchanger 452. Heat exchanger 452 is cooled by wind from electric fan 454. Electric motor 455 drives electric fan 454. Electric power from battery 360 is utilized for the operation of air conditioning unit 400 including the operation of compressor 453 and electric motor 455, and the operation of heater 460. Electric power received by plug-in mechanism 370 from the external power supply can also be utilized for the operation of air conditioning unit 400.

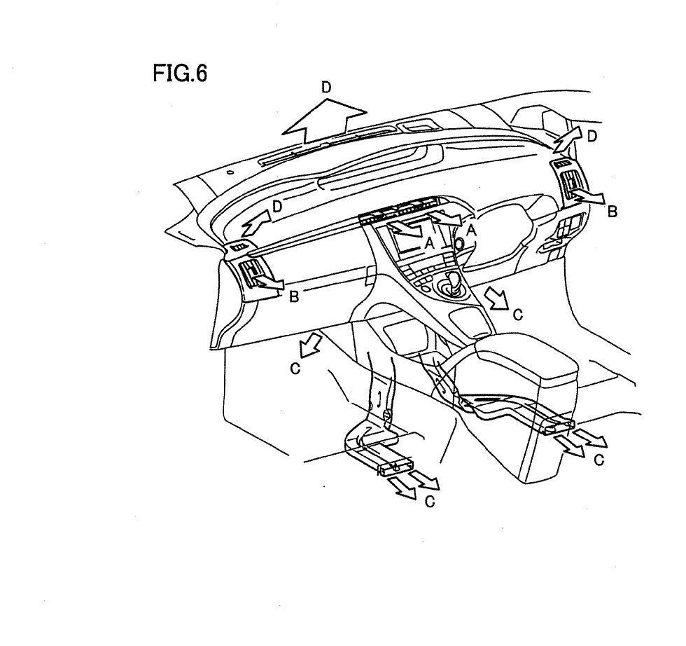

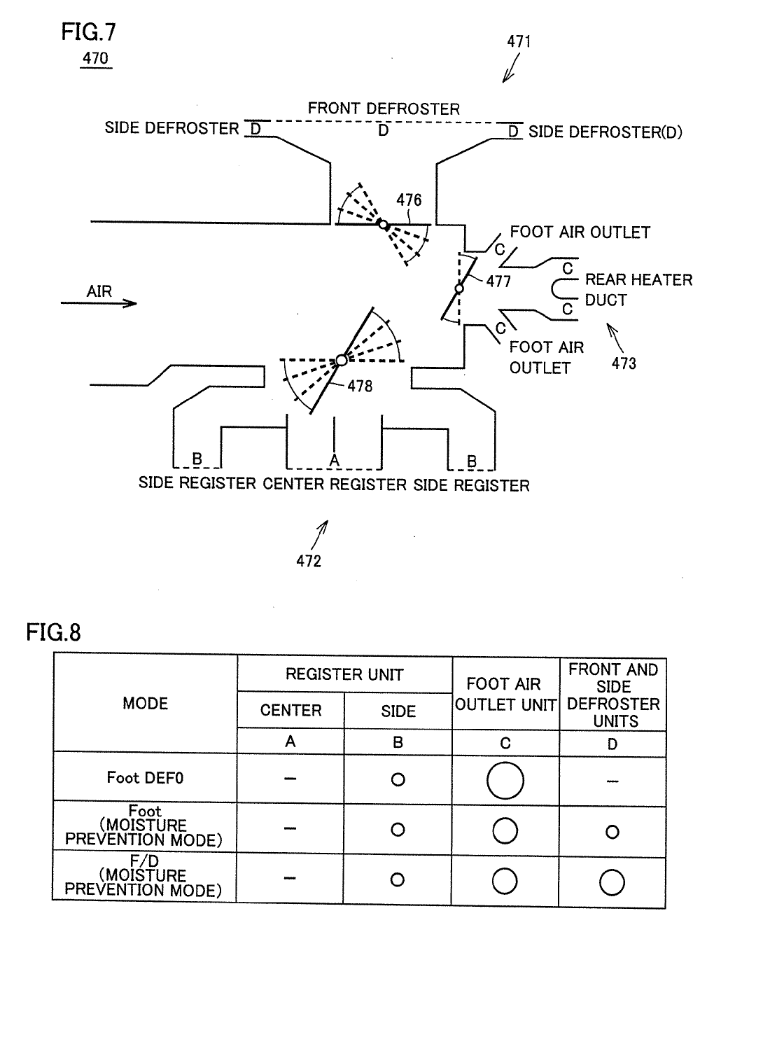

Air outlet 470 includes three air outlet units, that is, a defroster unit 471, a register unit 472, and a foot air outlet unit 473. Air is blown through defroster unit 471 upward from air outlet 470, namely, toward windshield 800 and side glass (not shown). Air is blown through register unit 472 in a front direction from air outlet 470. Air is blown through foot air outlet unit 473 downward from air outlet 470. Air outlet 470 will be described later in detail with reference to FIGS. 6 and 7.

Inside air sensor 480 measures an air temperature in passenger compartment 500 (Tr). Outside air sensor 490 measures an air temperature outside vehicle 100 (Tam).

Passenger compartment 500 is a space occupied by the user. Passenger compartment 500 is provided with a ventilation opening 510. In air conditioning, the air in passenger compartment 500 (indoor air) passes an exhaust path (not shown) through ventilation opening 510, and is exhausted to the outside of vehicle 100 through vent duct 600. The exhaust path may be provided to allow heat exchange between the exhausted indoor air and battery 360. Passenger compartment 500 is provided with an operating panel 520. The user operates operating panel 520 to perform air conditioning, for example. Passenger compartment 500 is further provided with a navigation system 530 and a weather sensor 540.

Operating panel 520 is provided with an operation button for setting vehicle 100 into a READY-ON state (a state in which the vehicle can run), for example. Where vehicle 100 is in the READY-ON state, ECU 200 can determine that the user is in the vehicle, and if not so, that is, where vehicle 100 is in a READY-OFF state (a state in which the vehicle cannot run), ECU 200 can determine that the user is not in the vehicle. A sensor may be provided in a driver's seat to determine whether the user is in the vehicle or not.

Navigation system 530 is configured to be capable of acquiring information about a current position of vehicle 100 using the GPS (Global Positioning System) function and the like. Navigation system 530 is also configured to be capable of acquiring weather information about various locations through the Internet and the like. Vehicle 100 can thus obtain weather information about the current position. A rain sensor for sensing an amount of raindrops deposited on the window glass such as windshield 800 or a solar radiation amount sensor for sensing an amount of solar radiation on windshield 800 can be used as weather sensor 540. That is, vehicle 100 can obtain weather information about the current position with weather sensor 540 as well. This weather information may be utilized for air conditioning of vehicle 100, as will be described later. Weather sensor 540 may be provided in other locations than in passenger compartment 500, as long as it can sense the weather.

Communication unit 700 communicates with the outside of vehicle 100. Communication unit 700 makes wireless communication with the electronic key as shown in FIG. 1, for example.

With the structure described above, vehicle 100 can charge battery 360 by utilizing the electric power from the power supply outside vehicle 100. Air conditioning is performed by ECU 200 controlling air conditioning unit 400. Air conditioning may be performed before the user rides in vehicle 100 (pre-air conditioning). The user can operate the electronic key described previously to perform the pre-air conditioning (remote pre-air conditioning). Air conditioning is also performed while the user is in vehicle 100 (operated air conditioning). The user can operate operating panel 520 or operate the electronic key to perform the operated air conditioning.

In the heating operation, warm air is often blown through foot air outlet unit 473 (a foot mode is executed) from the viewpoint of heating efficiency of passenger compartment 500 and the like. On the other hand, windshield 800 may be fogged by the heating operation. In that case, warm air is blown not only through foot air outlet unit 473 but also through defroster unit 471 (moisture prevention is performed). The warm air blown through defroster unit 471 prevents moisture from forming on windshield 800.

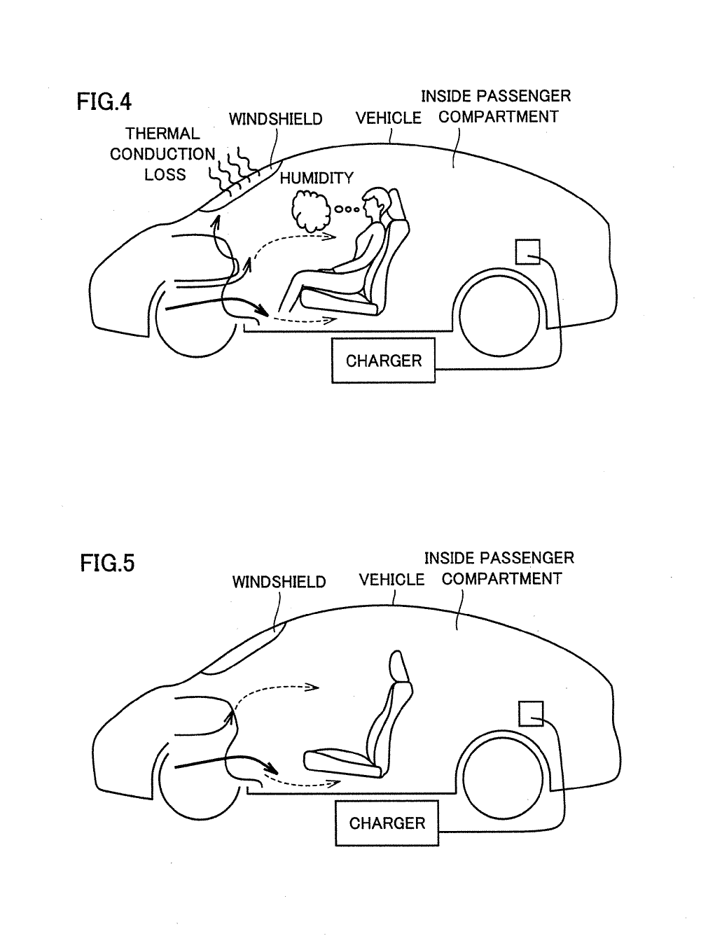

Whether fogging occurs or not on window glass such as a windshield depends on whether a user is in the vehicle or not. FIGS. 4 and 5 are diagrams for illustrating a cause of occurrence of fogging of window glass. Where the user is in the vehicle, as shown in FIG. 4, the humidity in a passenger compartment increases by the user's breathing (occupant breathing). When heating is performed while the humidity in the passenger compartment is increasing, the windshield is fogged. The windshield fogging results in poor visibility of the user. Accordingly, in the operated air conditioning while the user is in the vehicle, a moisture prevention mode is executed. That is, warm air blowing for moisture prevention is carried out through the defroster unit toward the windshield. However, thermal energy of such warm air for moisture prevention corresponds to thermal conduction loss at the windshield. That is, it corresponds to energy loss in the heating operation. It is noted that the vehicle may be charged by a charger from a power supply outside the vehicle in the heating operation, as shown in FIG. 4.

On the other hand, where the user is not in the vehicle, as shown in FIG. 5, the humidity increase by the occupant breathing does not occur in the passenger compartment. Accordingly, in the remote pre-air conditioning while the user is not in the vehicle, the moisture prevention mode does not need to be executed in the vehicle. That is, referring to FIG. 3, in vehicle 100, ECU 200 controls air conditioning unit 400 such that the execution of the moisture prevention mode is more limited in the remote air conditioning (or the remote pre-air conditioning) than in the operated air conditioning. That the execution of the moisture prevention mode is limited means that there are less states (or smaller frequency or the like) in which the moisture prevention mode is allowed in the remote pre-air conditioning than in the operated air-conditioning. It is noted that the vehicle may be charged by the charger from the power supply outside the vehicle in the heating operation, as shown in FIG. 5.

FIGS. 6 and 7 are diagrams for illustrating the details of the air outlet (air outlet 470 in FIG. 3) for blowing air into the passenger compartment in the heating operation. FIG. 6 is a diagram for illustrating air blowing through the units of the air outlet provided on a front side in the passenger compartment. As shown in FIG. 6, air is blown in directions of arrows A to D through the units of the air outlet. FIG. 7 is a diagram for illustrating a more detailed structure of air outlet 470 in FIG. 3. The air supplied to air outlet 470 is blown through defroster unit 471, register unit 472, and foot air outlet unit 473. The blowing through defroster unit 471 corresponds to arrows D in FIG. 6. The blowing through register unit 472 corresponds to arrows A and B in FIG. 6. The blowing through foot air outlet unit 473 corresponds to arrows C in FIG. 6. Which unit is used to blow the air supplied to air outlet 470 is determined by opened/closed states of doors 476 to 478. The opening/closing of doors 476 to 478 is controlled by air conditioning unit 400, ECU 200 or the like shown in FIG. 3.

As has been described with reference to FIGS. 3, 6 and 7, air outlet 470 can blow air through defroster unit 471, register unit 472, and foot air outlet unit 473. As will be described later, in the embodiment, various modes are executed in which the amounts of air blown through defroster unit 471, register unit 472, and foot air outlet unit 473 are appropriately adjusted.

FIG. 8 is a diagram for illustrating some of the various modes. As shown in FIG. 8, the various modes include a FootDEF0 mode, a Foot mode, and an F/D mode. The sign “−” in FIG. 8 indicates that air is not blown, and the size of an outlined circle indicates the magnitude of the amount of blown air. In the FootDEF0 mode, air blowing through the foot air outlet unit is carried out. Here, air blowing through the defroster unit is not carried out. Thus, most of the air conditioning (heating) energy is utilized to heat the passenger compartment. In the Foot mode, air blowing through the defroster unit is carried out in addition to the air blowing through the foot air outlet unit. Thus, in the Foot mode, moisture is prevented from forming on the windshield and the like. In the Foot mode in which the air blowing through the defroster unit is carried out, the amount of air blown through the foot air outlet unit is reduced as compared to the amount in the FootDEF0 mode. This results in energy loss in the heating operation. In the F/D mode, the amount of air blown through the defroster unit is increased as compared to the amount in the Foot mode, to be equal to the amount of air blown through the foot air outlet unit. The F/D mode can provide greater effect of preventing moisture than the Foot mode. By selecting among these three modes, that is, the FootDEF0 mode, the Foot mode, and the F/D mode, energy loss in the heating operation is reduced in the vehicle according to the embodiment.

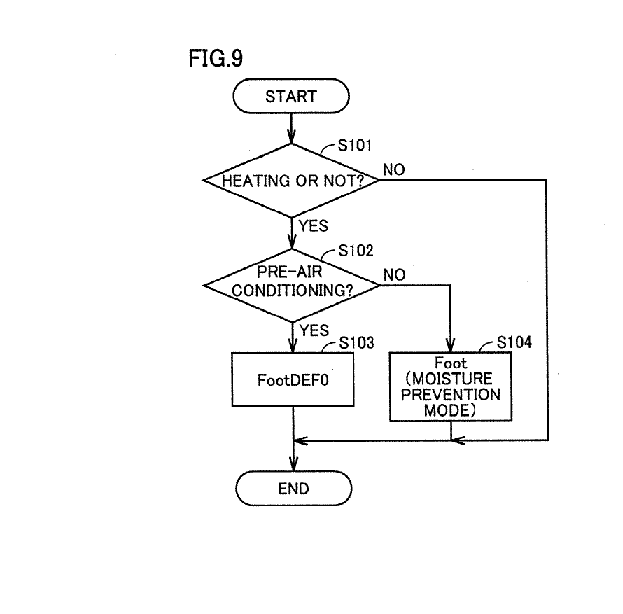

FIG. 9 is a flow chart for illustrating processing executed in air conditioning. The processing of this flow chart is executed by ECU 200 shown in FIG. 3. The processing shown in this flow chart is started by the user's operation concerning air conditioning, for example.

Referring to FIG. 9, it is initially determined whether air conditioning (heating) is required or not (step S101). It is determined that heating is required if target blow temperature TAO, calculated (computed) from a set temperature of air conditioning set by the user's operation, for example, is higher than temperature in the passenger compartment Tam, and it is determined that heating is not required if TAO is lower than Tam. Where heating is required (YES in step S101), the processing proceeds to step S102. On the other hand, where heating is not required (NO in step S101), the processing of the flow chart ends.

In step S102, it is determined whether the pre-air conditioning is to be performed or not. For example, where the user is not in the vehicle (where the vehicle is in the READY-OFF state), it is determined that the pre-air conditioning is to be performed. Conversely, where the user is in the vehicle, it is determined that the pre-air conditioning is not to be performed (the operated air conditioning is to be performed, for example). Where the pre-air conditioning is to be performed (YES in step S102), the processing proceeds to step S103. On the other hand, where the pre-air conditioning is not to be performed (NO in step S102), the processing proceeds to step S104.

In step S103, the FootDEF0 mode is selected. Thus, the heating operation in the FootDEF0 mode is executed. The processing of the flow chart subsequently ends.

In step S104, the Foot mode is selected. Thus, the heating operation in the Foot mode is executed. The processing of the flow chart subsequently ends.

According to the flow chart shown in FIG. 9, in the pre-air conditioning, the heating operation in the FootDEF0 mode is executed. Accordingly, there is no energy loss caused by the warm air blowing through the defroster unit.

[First Modification]

When an air temperature outside the vehicle (outside air temperature) is low, the temperature of the window glass such as the windshield becomes lower than the outside air temperature due to radiation cooling, which may cause moisture in the air to directly adhere to the window glass to form frost (frosting may occur). It is thus preferable to perform air conditioning in consideration of the outside air temperature. Specifically, the temperature of the window glass may decrease by about 4 to 5° C., for example, due to radiation cooling. In that case, if the outside air temperature is as low as about 5° C., the temperature of the window glass may reach 0° C. or less due to radiation cooling. When the temperature of the window glass reaches 0° C. or less, frost forms from the moisture that has adhered to the window glass. In addition, where it is snowing, the snow that has adhered to the window glass is accumulated without melting. To prevent such a problem, it is effective to sufficiently heat (prevent moisture from forming on) the window glass by blowing a larger amount of warm air through the defroster unit and the like. That is, the F/D mode in which a larger amount of warm air is blown through the defroster unit than in the Foot mode (FIG. 8) may be utilized.

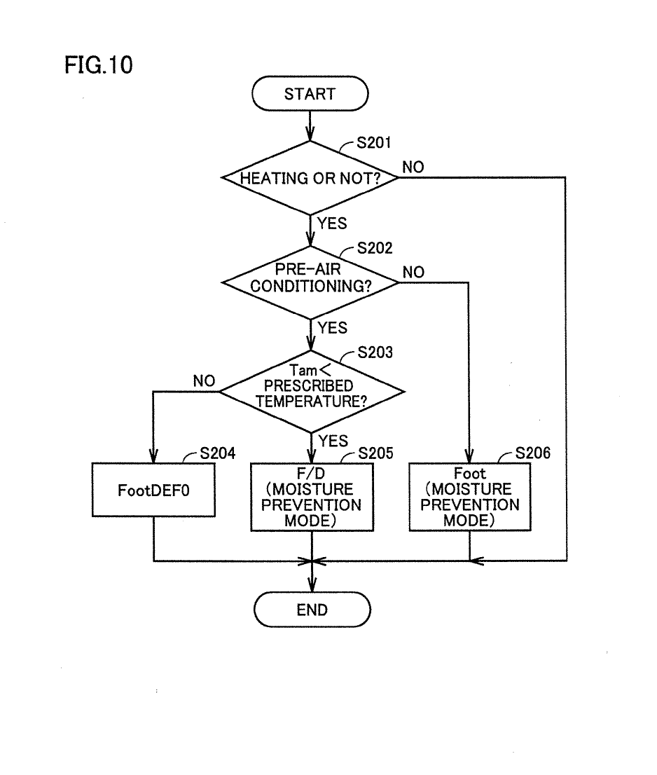

FIG. 10 is a flow chart for illustrating processing executed in air conditioning in consideration of an outside air temperature. Since step S201 in FIG. 10 is the same as step S101 in FIG. 9, the description thereof is not repeated.

Referring to FIG. 10, it is determined in step S202 whether the pre-air conditioning is to be performed or not. Where the pre-air conditioning is to be performed (YES in step S202), the processing proceeds to step S203. On the other hand, where the pre-air conditioning is not to be performed (NO in step S202), the processing proceeds to step S206.

In step S203, it is determined whether outside air temperature Tam is lower than a prescribed temperature or not. The prescribed temperature is preferably set to about 5° C., for example. This is because, as was described previously, the temperature of the window glass may decrease by about 4 to 5° C. from the outside air temperature (about 5° C. here) to reach 0° C. or less due to radiation cooling. Where Tam is lower than the prescribed temperature (YES in step S203), the processing proceeds to step S205. Where Tam is higher than the prescribed temperature (NO in step S203), the processing proceeds to step S204. It is noted that where Tam and the prescribed temperature are equal, the processing may proceed to either step S204 or step S205.

In step S204, the FootDEF0 mode is selected, and the heating operation is executed. The processing of the flow chart subsequently ends. In step S205, the F/D mode is selected, and the heating operation is executed. The processing of the flow chart subsequently ends. In step S206, the Foot mode is selected, and the heating operation is executed. The processing of the flow chart subsequently ends.

According to the flow chart shown in FIG. 10, in the pre-air conditioning, the heating operation in the F/D mode is executed where the outside air temperature is lower than the prescribed temperature. Accordingly, the window glass is sufficiently heated to prevent the formation of frost and the like on the window glass.

[Second Modification]

Even where frost forms on the window glass, the frost may melt by solar heat and the like. In that case, the moisture prevention mode does not need to be executed. It is thus preferable to perform air conditioning in consideration of the weather. Weather information is acquired with navigation system 530 and weather sensor 540 shown in FIG. 3.

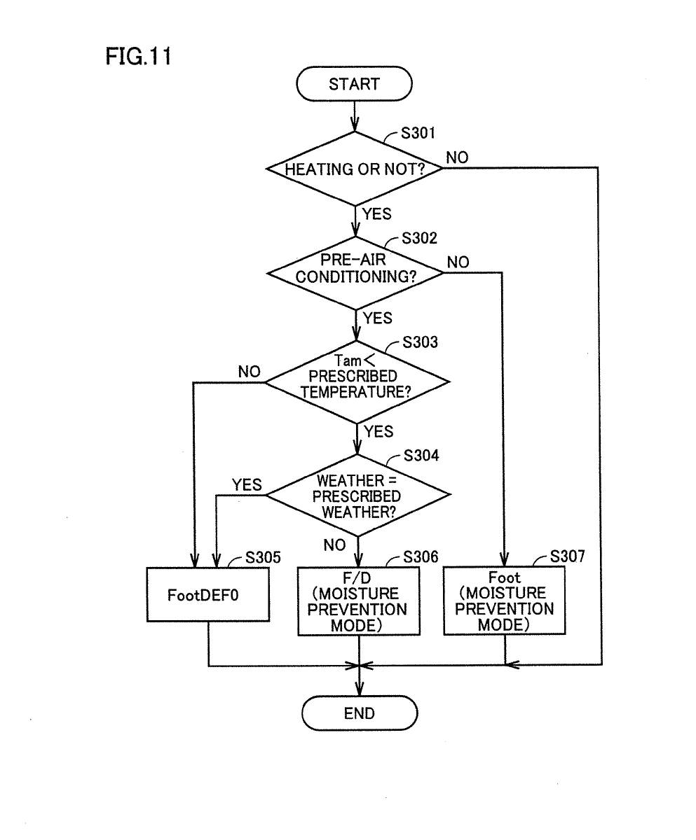

FIG. 11 is a flow chart for illustrating processing executed in air conditioning in consideration of the weather. Since steps S301, S302 and S307 in FIG. 11 are the same as steps S201, S202 and S206 in FIG. 10, the description thereof is not repeated.

Referring to FIG. 11, in step S303, it is determined whether outside air temperature Tam is lower than a prescribed temperature or not. This prescribed temperature may have a value the same as that of the prescribed temperature in step S203 shown in FIG. 10. Where Tam is lower than the prescribed temperature (YES in step S303), the processing proceeds to step S304. On the other hand, where Tam is higher than the prescribed temperature (NO in step S303), the processing proceeds to step S305.

In step S304, it is determined whether the weather is prescribed weather or not. The prescribed weather is, for example, clear weather. This is because it can be considered that clear weather allows the window glass to receive solar heat enough to melt the frost. Instead of the clear weather, weather that allows the window glass to receive solar heat may be set as the prescribed weather. Where the weather is the prescribed weather (YES in step S304), the processing proceeds to step S305. On the other hand, where the weather is not the prescribed weather (NO in step S304), the processing proceeds to step S306.

In step S305, the FootDEF0 mode is selected, and heating is performed. In step S306, the F/D mode is selected, and heating is performed. In step S308, the Foot mode is selected, and heating is performed. After any of the processes in steps S305, S306 and S308 is executed, the processing of this flow chart ends.

According to the flow chart shown in FIG. 11, where the weather is the prescribed weather (clear weather, for example), the heating operation in the FootDEF0 mode is executed. Accordingly, there is no energy loss caused by the warm air blowing through the defroster unit.

[Third Modification]

A vehicle generally includes a plurality of seats, some of which are not used by a user (empty seats) while the user is in the vehicle. It is not efficient to blow warm air toward the empty seats and the area around them in the heating operation. It is thus preferable to perform air conditioning in consideration of which seat is used by the user.

The air conditioning in consideration of empty seats can be performed in vehicle 100 by, for example, allowing the user to specify (in advance) a seat to be used (seated) by the user by operation of operating panel 520 in passenger compartment 500 shown in FIG. 3. The user may specify a seat to be used by operating the electronic key shown in FIG. 1 and the like.

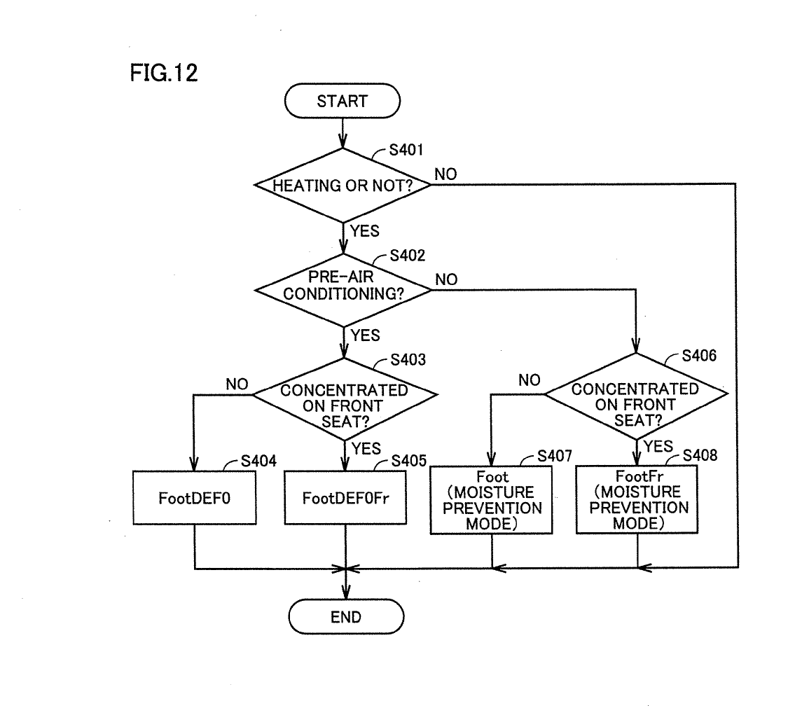

FIG. 12 is a flow chart for illustrating processing executed in air conditioning in consideration of whether the user uses only a front seat or not. Since step S401 in FIG. 12 is the same as step S101 in FIG. 9, the description thereof is not repeated.

Referring to FIG. 12, in step S402, it is determined whether the pre-air conditioning is to be performed or not. Where the pre-air conditioning is to be performed (YES in step S402), the processing proceeds to step S403. On the other hand, where the pre-air conditioning is not to be performed (NO in step S402), the processing proceeds to step S406.

In step S403, it is determined whether a seat used by the user is only the front seat, namely, is concentrated on the front seat. This determination is made, for example, based on the information set by the user operating the electronic key or the operating panel, as was described previously. Where a seat used by the user is concentrated on the front seat (YES in step S403), the processing proceeds to step S405. On the other hand, where a seat used by the user is not concentrated on the front seat (NO in step S403), the processing proceeds to step S404.

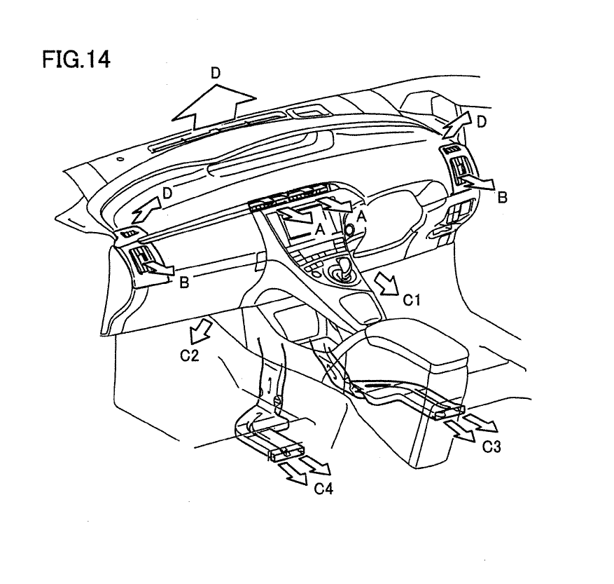

In step S404, the FootDEF0 mode is selected, and heating is performed. step S405, a FootDEF0Fr mode is selected, and heating is performed. In the FootDEF0Fr mode, warm air blowing toward the front (front seat) of the vehicle is carried out, but warm air blowing toward the back (back seat) of the vehicle is not carried out. Warm air blowing through the defroster unit is not carried out. The FootDEF0Fr mode will be described later with reference to FIG. 14. After any of the processes in steps S404 and S405 is executed, the processing of this flow chart ends.

In step S406, it is determined whether a seat used by the user is concentrated on the front seat. Where a seat used by the user is concentrated on the front seat (YES in step S406), the processing proceeds to step S408. On the other hand, where a seat used by the user is not concentrated on the front seat (NO in step S406), the processing proceeds to step S407.

In step S407, the Foot mode is selected, and heating is performed. In step S408, a FootFr mode is selected, and heating is performed. In the FootFr mode, warm air blowing toward the front (front seat) of the vehicle is carried out, but warm air blowing toward the back (back seat) of the vehicle is not carried out. In addition, warm air blowing through the defroster unit is carried out. The FootFr mode will be described later with reference to FIG. 14. After any of the processes in steps S407 and S408 is executed, the processing of this flow chart ends.

According to the flow chart shown in FIG. 12, where the user is seated only on the front seat of the vehicle, electric power consumed for heating of the other seats (back seat) can be saved.

[Fourth Modification]

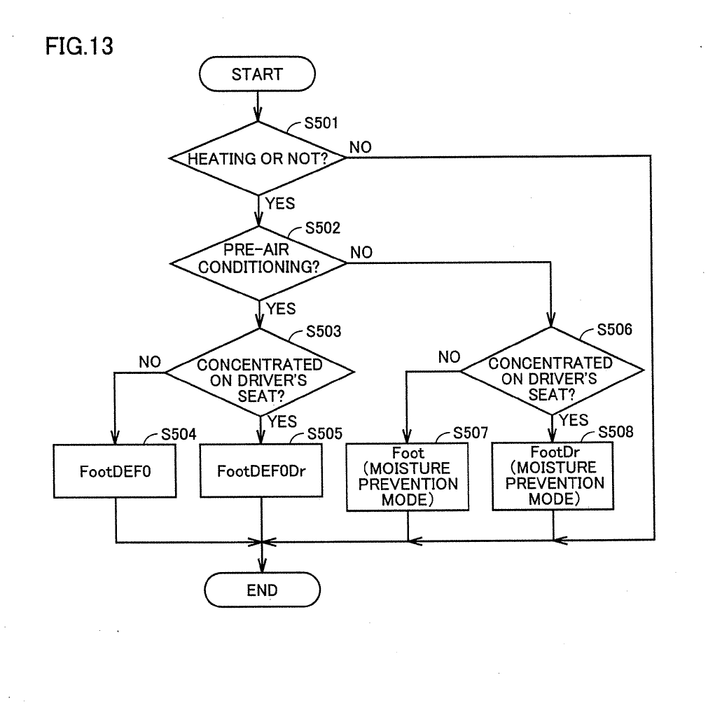

FIG. 13 is a flow chart for illustrating, as another example, processing executed in air conditioning in consideration of whether a user uses only a driver's seat or not. Since step S501 in FIG. 13 is the same as step S101 in FIG. 9, the description thereof is not repeated.

Referring to FIG. 13, it is determined in step S502 whether the pre-air conditioning is to be performed or not. Where the pre-air conditioning is to be performed (YES in step S502), the processing proceeds to step S503. On the other hand, where the pre-air conditioning is not to be performed (NO in step S502), the processing proceeds to step S506.

In step S503, it is determined whether a seat used by the user is only the driver's seat, namely, is concentrated on the driver's seat. Where a seat used by the user is concentrated on the driver's seat (YES in step S503), the processing proceeds to step S505. On the other hand, where a seat used by the user is not concentrated on the driver's seat (NO in step S503), the processing proceeds to step S504.

In step S504, the FootDEF0 mode is selected, and heating is performed. In step S505, a FootDEF0Dr mode is selected, and heating is performed. In the FootDEF0Dr mode, warm air blowing toward the driver's seat of the vehicle is carried out, but warm air blowing toward the other seats is not carried out. Warm air blowing through the defroster unit is not carried out. The FootDEF0Dr mode will be described later with reference to FIG. 14. After any of the processes in steps S504 and S505 is executed, the processing of this flow chart ends.

In step S506, it is determined whether a seat used by the user is concentrated on the driver's seat. Where a seat used by the user is concentrated on the driver's seat (YES in step S506), the processing proceeds to step S508. On the other hand, where a seat used by the user is not concentrated on the driver's seat (NO in step S506), the processing proceeds to step S507.

In step S507, the Foot mode is selected, and heating is performed. In step S508, a FootDr mode is selected, and heating is performed. In the FootDr mode, warm air blowing toward the driver's seat of the vehicle is carried out, but warm air blowing toward the other seats is not carried out. In addition, warm air blowing through the defroster unit is carried out. The FootDr mode will be described later with reference to FIG. 14. After any of the processes in steps S507 and S508 is executed, the processing of this flow chart ends.

According to the flow chart shown in FIG. 13, where the user is seated only on the driver's seat of the vehicle, electric power consumed for heating of the other seats can be saved.

FIG. 14 is a diagram for illustrating the warm air blowing in the modes selected in steps S405, S408 in FIG. 12 and steps S505, S508 in FIG. 13.

FIG. 14 is a diagram for illustrating, as with FIG. 6, air blowing through the units of the air outlet provided on the front side in the passenger compartment. Arrows A to C in FIG. 14 are the same as those in FIG. 6. In FIG. 14, arrows C shown in FIG. 6 are classified into arrows C1 to C4. Arrows C1 and C2 indicate the air blowing toward the front seat. Arrow C1 (or arrow C2) indicates the air blowing toward the driver's seat. Arrows C3 and C4 indicate the air blowing toward the back seat. The air blowing indicated with arrows C1 to C4 may be independently controlled. Such control can be implemented by, for example, providing a door for each of two foot air outlets (which correspond to arrows C1 and C2 in FIG. 14, for example) and two rear heat ducts (which correspond to arrows C3 and C4 in FIG. 14, for example), instead of door 477 shown in FIG. 7.

Referring to FIG. 14, in the FootDEF0Fr mode selected in step S405 in FIG. 12, warm air blowing is carried out as indicated with arrows B, C1 and C2. Thus, only the front seat of the vehicle is heated. Warm air blowing through the defroster unit is not carried out. In the FootFr mode selected in step S406 in FIG. 12, warm air blowing is carried out as indicated with arrows B, C1, C2 and D. Thus, the front seat of the vehicle is heated in a focused manner. In addition, warm air blowing through the defroster unit is carried out. In the FootDEF0Dr mode selected in step S505 in FIG. 13, warm air blowing is carried out as indicated with arrows B and C1. Thus, only the driver's seat of the vehicle is heated. Warm air blowing through the defroster unit is not carried out. In the FootDr mode selected in step S506 in FIG. 13, warm air blowing is carried out as indicated with arrows B, C1 and D. Thus, the driver's seat of the vehicle is heated in a focused manner. In addition, warm air blowing through the defroster unit is carried out.

Lastly, the embodiment of the present invention will be summarized. Referring to FIGS. 3 and 8, vehicle 100 according to the embodiment includes an air conditioning apparatus (air conditioning unit 400) for heating inside of passenger compartment 500 using electric power of an external power supply or of vehicle 100, the apparatus being configured to be capable of executing a foot mode to blow air toward feet (FootDEF0 in FIG. 8) and a moisture prevention mode to blow air also through defroster unit 471 while the foot mode is selected (Foot in FIG. 8), and a control unit (ECU 200) that causes the air conditioning apparatus to execute remote air conditioning in which air conditioning is performed while a user is not in vehicle 100, and operated air conditioning in which air conditioning is performed by the user's operation while the user is in vehicle 100. The control unit (ECU 200) limits the execution of the moisture prevention mode in the remote air conditioning more than the execution of the moisture prevention mode in the operated air conditioning.

Preferably, as shown in FIG. 10, the control unit (ECU 200) controls the air conditioning apparatus (air conditioning unit 400) such that in the remote air conditioning, the moisture prevention mode is executed (step S205) where an air temperature outside the vehicle (Tam) is lower than a prescribed temperature (YES in step S203).

Preferably, as shown in FIG. 11, the control unit (ECU 200) controls the air conditioning apparatus (air conditioning unit 400) such that in the remote air conditioning, the foot mode is executed (step S305) where weather is prescribed weather (YES in step S304), and the moisture prevention mode is executed (step S306) where weather is not the prescribed weather (NO in step S304).

Preferably, as shown in FIG. 12, the control unit (ECU 200) controls the air conditioning apparatus (air conditioning unit 400) such that air is blown only toward a front seat of vehicle 100 (steps S405, S408) where a seat used by the user is concentrated on the front seat of vehicle 100.

Preferably, as shown in FIG. 13, the control unit (ECU 200) controls the air conditioning apparatus (air conditioning unit 400) such that air is blown only toward a driver's seat of vehicle 100 (steps S505, S508) where a seat used by the user is concentrated on the driver's seat of vehicle 100.

In another aspect of the embodiment, a vehicle includes an air conditioning apparatus (air conditioning unit 400) for heating inside of passenger compartment 500 using electric power of an external power supply or of vehicle 100, the apparatus being configured to be capable of executing a foot mode to blow air toward feet (FootDEF0 in FIG. 8) and a moisture prevention mode to blow air also through a defroster unit while the foot mode is selected (Foot in FIG. 8), and a control unit (ECU 200) that causes the air conditioning apparatus (air conditioning unit 400) to execute remote air conditioning in which air conditioning is performed by operation of a remote controller (the electronic key shown in FIG. 1, for example), and operated air conditioning in which air conditioning is performed by operation of operating panel 520 in passenger compartment 500. The control unit (ECU 200) limits the execution of the moisture prevention mode in the remote air conditioning more than the execution of the moisture prevention mode in the operated air conditioning.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A vehicle comprising:
an air conditioning apparatus for heating inside of a passenger compartment using electric power of an external power supply or of said vehicle, said apparatus being configured to be capable of executing a foot mode to blow air toward feet and a moisture prevention mode to blow air also through a defroster unit while said foot mode is selected; and
a control unit that causes said air conditioning apparatus to execute remote air conditioning in which air conditioning is performed while a user is not in said vehicle, and operated air conditioning in which air conditioning is performed by the user's operation while the user is in said vehicle,
said control unit limiting the execution of said moisture prevention mode in said remote air conditioning more than the execution of said moisture prevention mode in said operated air conditioning.

2. The vehicle according to claim 1, wherein
said control unit controls said air conditioning apparatus such that in said remote air conditioning, said moisture prevention mode is executed where an air temperature outside said vehicle is lower than a prescribed temperature.

3. The vehicle according to claim 1, wherein
said control unit controls said air conditioning apparatus such that in said remote air conditioning, said foot mode is executed where weather is prescribed weather, and said moisture prevention mode is executed where weather is not said prescribed weather.

4. The vehicle according to claim 1, wherein
said control unit controls said air conditioning apparatus such that air is blown only toward a front seat of said vehicle where a seat used by the user is concentrated on said front seat.

5. The vehicle according to claim 1, wherein
said control unit controls said air conditioning apparatus such that air is blown only toward a driver's seat of said vehicle where a seat used by the user is concentrated on said driver's seat.

6. A vehicle comprising:
an air conditioning apparatus for heating inside of a passenger compartment using electric power of an external power supply or of said vehicle, said apparatus being configured to be capable of executing a foot mode to blow air toward feet and a moisture prevention mode to blow air also through a defroster unit while said foot mode is selected; and
a control unit that causes said air conditioning apparatus to execute remote air conditioning in which air conditioning is performed by operation of a remote controller, and operated air conditioning in which air conditioning is performed by operation of an operating panel in said passenger compartment,
said control unit limiting the execution of said moisture prevention mode in said remote air conditioning more than the execution of said moisture prevention mode in said operated air conditioning.
